(19) United States
(12) Patent Application Publication
(10) Pub. No.: US 2014/0234537 A1
(43) Pub. Date: Aug. 21, 2014

(54) METHOD FOR MANUFACTURING AN ELECTRODE, AND INK FOR AN ELECTRODE

(71) Applicants: Sophie Chazelle, Vourey (FR); Willy Porcher, Grenoble (FR)

(72) Inventors: Sophie Chazelle, Vourey (FR); Willy Porcher, Grenoble (FR)

(73) Assignees: COMMISSARIAT A L'ENERGIE ATOMIQUE ET AUX ENERGIES ALTERNATIVES, Paris (FR); RENAULT S.A.S, Boulogne Billancourt (FR)

(21) Appl. No.: 14/343,553

(22) PCT Filed: Sep. 6, 2012
(86) PCT No.: PCT/FR2012/000351

§ 371 Date: Mar. 7, 2014

(30) Foreign Application Priority Data
Sep. 9, 2011 (FR) 1102739

(51) Int. Cl. H01M 4/485; H01M 4/04; H01M 4/1391

(52) U.S. Cl. CPC H01M 4/485; H01M 4/1391; H01M 4/0404; H01M 2220/30
USPC 427/126.4; 427/126.3; 427/126.6; 252/182.1; 252/520.21

(57) ABSTRACT

The invention relates to a method for fabricating an electrode which includes coating of an aqueous ink over the whole or part of a current collector followed by drying of said ink. The aqueous ink is produced by acidification of an aqueous dispersion including an electrochemically active material having a titanium and lithium oxide base until a pH value comprised between 9.0±0.1 and 10.0±0.1 is obtained. The invention also relates to an aqueous ink for an electrode including an electrochemically active material having a titanium and lithium oxide base and having a pH between 9.0±0.1 and 10.0±0.1, preferably equal to 10±0.1.

### BACKGROUND OF THE INVENTION

The invention relates to a method for fabricating an electrode comprising coating of an aqueous ink over the whole of part of a current collector followed by drying of said ink.

The invention also relates to an aqueous ink for an electrode comprising an electrochemically active material having a titanium and lithium oxide base.

### STATE OF THE ART

Titanium and lithium oxides have revealed themselves to be interesting candidates for producing a high-voltage electrode with a rated voltage situated between 1.4V and 2.0 V vs Li⁺/Li, constituting an alternative to graphite in production of batteries, in particular lithium batteries. Titanium oxides further present a low toxicity and a low cost while at the same time presenting interesting electrochemical performances.

Insertion of lithium is in fact characterized by a voltage plateau at 1.55V leading to the electrochemical reaction described by:

Li₄Ti₅O₁₂+3Li⁺+3e⁻ [symbol] Li₇Ti₅O₁₂

This insertion potential enables the use of an aluminium current collector that is less onerous in comparison with the copper or nickel generally used for graphite-base electrodes.

At the present time, electrodes for lithium batteries or storage cells are generally fabricated from an ink formed by mixing a powdery electrochemically active material, a binder and an electron conductor which are dispersed in an organic or aqueous solvent.

An ink/collector assembly is obtained by coating the ink on a conventionally metallic current collector such as an aluminium or copper strip.

The coating step is conventionally followed by drying of the ink/collector assembly to remove the solvent contained in the ink. The electrode formed in this way is then composed of a current collector partially or totally covered by a film adhering to the current collector, containing the electrochemically active material.

The binder ensures the mechanical strength of the electrode and cohesion of the electrode in particular by improving the adhesion of the film on the current collector. The binders for electrodes commonly used at the present time are polymers soluble in organic solvents such as polyvinylidene fluoride, noted PVDF.

Formulation of an electrode by organic route does however present the disadvantage of using an organic solvent that is combustible, volatile, inflammable and sometimes toxic. For example purposes, N-methyl-2-pyrrolidone, noted NMP, can be cited, commonly used to solubilise PVDF, classified as a Carcinogenic Mutagenic Reprotoxic (CMR) compound the use of which requires particular handling conditions to be implemented.

To overcome the drawbacks related to the use of an organic solvent, certain authors have proposed electrode formulation by aqueous route. Polymer binders soluble in an aqueous solvent have in particular been proposed to remedy the drawbacks of PVDF. In particular, research has been directed towards carboxymethyl cellulose, noted CMC, nitrile butadiene rubber, noted NBR, and styrene butadiene rubber, noted SBR.

For example purposes, the document WO2004045007 can be cited in which describes a method for preparation by aqueous route of an electrode covered by a film containing an electrochemically active material.

The article by Kim GT et al. (Journal of Power Sources (2011), 196, 4, 2187-2194) can also be cited which describes a method for fabricating an electrode for lithium-ion batteries using carboxymethyl cellulose (CMC) as binder, Li₄Ti₅O₁₂ as anodic active material and LiFePO₄ as cathodic active material.

The document U.S. Pat. No. 6,019,802 also proposes to produce lithium-ion batteries from an aqueous dispersion on a current collector. The aqueous dispersion comprises for example an active material, a conducting agent and a dispersion agent such as CMC.

### OBJECT OF THE INVENTION

The object of the invention is to obtain a method for fabricating an electrode that is ecological and economic, enabling a dense electrode to be obtained without deteriorating the electrochemical performances of the electrode, and sufficiently flexible to be wound.

A further object of the invention is also to obtain an electrode able to be used in a battery, in particular a lithium battery, and having stable mechanical properties with use, in particular an enhanced mechanical strength ensuring cohesion of the electrode when charging and/or discharging of the battery is performed.

It is a further object of the invention to propose an ecological and economic aqueous ink designed to formulate an electrode presenting improved electrochemical and mechanical properties.

These objects tend to be met by the appended claims.

### BRIEF DESCRIPTION OF THE DRAWINGS

Other advantages and features will become more clearly apparent from the following description of particular embodiments of the invention given for non-restrictive example purposes and represented in the appended drawings, in which:

FIG. 1 represents the first discharge cycle of a Li₄Ti₅O₁₂ electrode contained in a button cell facing metallic lithium, formulated by aqueous route according to a particular embodiment of the invention, comparatively with two Li₄Ti₅O₁₂ electrodes respectively formulated by aqueous and organic route according to the prior art.

FIG. 2 represents on the same graph plots of compression curves obtained from three Li₄Ti₅O₁₂ electrodes, formulated by aqueous route according to a particular embodiment of the invention, comparatively with three Li₄Ti₅O₁₂ electrodes formulated by organic route according to the prior art.

### DESCRIPTION OF PARTICULAR EMBODIMENTS

According to a particular embodiment, an aqueous ink for an electrode comprises an electrochemically active material having a titanium and lithium oxide base.

What is meant by aqueous ink is a formulation or a composition formed by one or more component(s) partially or totally dissolved in an aqueous solvent, i.e. a solvent mainly containing water. What is meant by solvent mainly containing water is according to a particular embodiment a solvent containing more than 95% in volume of water.

What is meant by electrochemically active material having a titanium and lithium oxide base is an electrochemically active material advantageously comprising at least 95% by weight of one or more titanium and lithium oxide(s).

It has surprisingly and unexpectedly been observed that aqueous inks containing an electrochemically active material having a titanium and lithium oxide base have a pH higher than or equal to 11, in particular those containing Li₄Ti₅O₁₂.

The titanium and lithium oxides dispersed in an ink for an electrode do in fact generate hydroxide ions in an aqueous solvent, in particular in water, which are responsible for the pH higher than or equal to 11.

Unlike aqueous inks of the prior art, the aqueous ink according to the invention has a pH comprised between 7.0±0.1 and 10.5±0.1 or advantageously between 9.0±0.1 and 10.0±0.1, and preferably equal to 10.0±0.1.

Advantageously, the pH of the aqueous ink is fixed at a value of more than 9.0±0.1. It has in fact experimentally been observed that the aqueous ink is less and less stable as it approaches neutrality, making coating of the aqueous ink on the current collector difficult, in particular on aluminium current collectors. What is meant by neutrality is a pH of about 7.0.

The “±” sign represents the notion of “plus or minus”, i.e. for a given value, the actual value will be able to oscillate around this given value plus or minus an oscillation value. In other words, what is meant by “9.0±0.1” is that the value concerned can vary between 8.9 and 9.1, the given value being 9.0 and the oscillation value being 0.1.

The quantity of aqueous solvent is adjusted so as to obtain a texture and/or a viscosity of the ink suitable for coating techniques commonly used in the field of electrode fabrication, while at the same time keeping the pH within the selected range. The viscosity of the aqueous ink is preferably comprised between 0.1 and 5 Pa·s for a velocity gradient of 100 s⁻¹.

The electrochemically active material having a titanium and lithium oxide base is advantageously chosen from Li₄Ti₅O₁₂, Li₍₄₋ₓ₎MₓTi₅O₁₂ and Li₄Ti_{(5-y)}N_{y}O₁₂, where x and y are respectively comprised between 0 and 0.2 and M and N are respectively chemical elements chosen from Na, K, Mg, Nb, Al, Ni, Co, Zr, Cr, Mn, Fe, Cu, Zn, Si and Mo.

The electrochemically active material having a titanium and lithium oxide base is preferably Li₄Ti₅O₁₂.

According to a preferred particular embodiment, the aqueous ink comprises the electrochemically active material, at least one electron conductor, at least one binder and water.

The binder is at least partially soluble in water. A binder soluble in water and non-toxic, in particular classified non CMR, will preferably be chosen. The binder can be chosen from carboxymethyl cellulose (CMC), nitrile butadiene rubber (NBR) and styrene-butadiene rubber (SBR).

The aqueous ink is designed to provide a solid layer of electrochemically active material on a current collector, by means of any known method, for example by coating on all or part of the current collector followed by drying of the aqueous ink to eliminate the solvent.

The aqueous ink is suitable for use for fabrication of an electrode, in particular for a battery electrode. The aqueous ink is more particularly designed for fabrication of an electrode for a lithium-ion battery or a lithium-ion storage cell.

According to a particular embodiment, a method for fabricating an electrode comprises coating of the aqueous ink described in the foregoing on all or part of a current collector followed by drying of said ink. The aqueous ink is produced by acidification of an aqueous dispersion comprising the electrochemically active material having a titanium and lithium oxide base described in the foregoing until a pH value comprised between 7.0±0.1 and 10.5±0.1, or advantageously comprised between 9.0±0.1 and 10±0.1, preferably equal to 10±0.1 is obtained.

Preferably, the acidification step is performed by addition under stirring of an acid aqueous solution in the aqueous dispersion.

The current collector is advantageously aluminium-base, preferably made from aluminium.

The method for fabricating an electrode advantageously comprises the following successive steps:
preparation of the aqueous ink,
producing an ink/collector assembly by coating of the aqueous ink on all or part of the current collector and,
drying of the aqueous ink to eliminate the aqueous solvent.

The drying step of the aqueous ink can optionally be followed by a calandering step enabling drying to be finalised, the porosity of the electrode to be fixed to a certain value and a certain thickness to be given.

Preparation of the aqueous ink is obtained by formulation of the aqueous dispersion, by means of any known method.

An electrode is obtained formed by a solid layer containing the electrochemically active material having a titanium and lithium oxide base on the current collector, said solid layer being in direct contact with the current collector.

Traces of aqueous solvent can remain in the solid layer obtained in this way after drying. Nevertheless, the remainder of aqueous solvent is not significant and does not exceed 0.1% by weight with respect to the total weight of the solid layer.

The thickness of the coating defines the grammage of the formed electrode. What is meant by grammage is the weight of the electrochemically active material per surface unit. From the specific capacity of the electrochemically active material forming the electrode and the grammage obtained, the surface capacity of the electrode can be calculated, expressed in mAh·cm⁻².

The applicant observed that aqueous inks comprising an electrochemically active material having a titanium and lithium oxide base degraded the current collector, in particular when it contains aluminium. In particular, the applicant discovered that a loss of electrochemical performance and mechanical strength of an electrode obtained from such an ink was due to the corrosive effect of this ink on the current collector.

In a pH domain greater than or equal to 11, corrosion of the aluminium accompanied by release of hydrogen is effectively observed, resulting from the following reaction:

Al+OH⁻+5H₂O→(Al(OH)₄(H₂O₂)₂)—+ 3/2 H₂

The use of an aqueous ink comprising the electrochemically active material having a titanium and lithium oxide base and having a pH of less than 11, in particular comprised between 7.0±0.1 and 10.5±0.1, or advantageously between 9.0±0.1 and 10.0±0.1, and preferably equal to 10±0.1, thus prevents any deterioration of the current collector and improves the interface between the solid layer and the current collector. The quality of the interface between the solid layer and the current collector is improved and ensures the electric continuity within the electrode. The electron conduction of the electrode formed in this way is consequently improved as it is its mechanical strength.

According to a preferred embodiment, a lithium-ion battery comprises at least one electrode comprising an aqueous ink described in the foregoing.

### Example

An aqueous dispersion is for example achieved by mixing 200 g of Li₄Ti₅O₁₂ initially in powder form, 150 ml of an aqueous solution with 3% by weight of CMC as binder, 10 g of carbon black as electron conductor and 120 ml of demineralised water.

The mixture is mechanically dispersed, by means of any known method, in order to break up the particles of carbon black and of Li₄Ti₅O₁₂. The targeted maximum particle size is 30 μm.

After dispersion, the acidification step is advantageously performed by addition, under stirring of an acid aqueous solution in the aqueous dispersion. The acid aqueous solution is a solution diluted beforehand at 45% and is conventionally incorporated in the aqueous dispersion under stirring. Typically, an acid of phosphoric, sulphuric or hydrochloric acid type is used.

The acidification step enables the pH to be advantageously adjusted to a value equal to 10±0.1. Monitoring of the pH is performed by means of a pH-meter.

A second binder is then incorporated in the acidified aqueous dispersion in order to adjust the viscosity of the final aqueous ink before the coating step to enable the quality of the coating to be optimised. 20 ml of SBR are for example added to the acidified aqueous dispersion as second binder.

The aqueous ink thus formed is then coated on all or part of an aluminium current collector, by means of any known method, for example by spreading of the ink on the current collector, so as to form a uniform and homogeneous layer of aqueous ink.

The water is then eliminated from the layer of aqueous ink by drying, by means of any known method, for example by drying in a drying oven or on line by means of a furnace at a temperature of 30° C. to 80° C. for 30 minutes to 24 hours. Advantageously, the temperature is 50° C.

An electrode is obtained formed by a solid layer containing Li₄Ti₅O₁₂ on the aluminium current collector. No trace of corrosion is observed.

### Electrochemical Testing

A series of electrodes, referenced LTO-a1, having a grammage of 16 mg/cm² and a surface capacity of 2.5 mAh·cm⁻² are fabricated according to the method of the example described above by coating of a layer of aqueous ink with a thickness of 300 μm on the aluminium current collector.

The LTO-al electrodes are then compressed or calandered at a pressure of 5 T.cm⁻² and then cut into the form of electrode pellets before being incorporated in a lithium battery, typically of “button cell” format facing lithium.

For comparative purposes, a series of electrodes referenced LTO-o1 obtained by organic route are also produced and inserted in a lithium battery of “button cell” type.

### Preparation of a “Button Cell” Lithium Battery Type

The lithium battery of “button cell” type is conventionally fabricated from a lithium electrode, the electrode to be tested and a separator of Celgard type made from polymer.

The negative electrode is formed by a circular film with a diameter of 16 mm and a thickness of 120 μm deposited on a stainless steel disk acting as current collector. The separator is imbibed by a liquid electrolyte having a base of LiPF6 at a concentration of 1mol/l in a EC/DEC mixture in a 1/1 solvent volume.

Testing of the “button cell” lithium battery type

Two lithium batteries of “button cell type, referenced LTO-a1 for the first series containing the electrode obtained by aqueous route and LTO-o1 for the second series containing the electrode obtained by organic route, are tested at a temperature of 20° C., in intentiostatic mode with a C/10 discharge rate at 10C (where C represents the rated capacity of the battery) between a potential of 1V and 2V vs. Li+/Li.

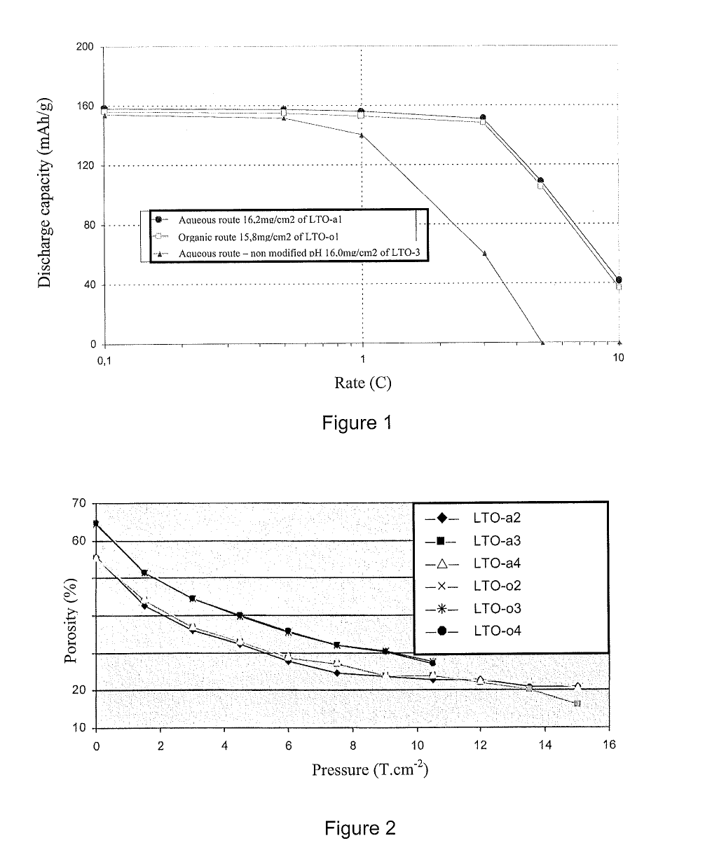

The specific capacities on discharge according to the discharge rate for each lithium battery LTO-al and LTO-o1 are represented in FIG. 1.

As illustrated in FIG. 1, the comparative electrochemical tests show that the capacity of lithium batteries LTO-a1 and LTO-o1 is substantially identical. In the example of the battery referenced LTO-a1, the electrode is fabricated by aqueous route according to the invention with a grammage of 16.2 mg/cm² and the electrode of the LTO-o1 battery has a grammage of 15.8 mg/cm².

A third lithium battery is fabricated by means of a strictly identical operating mode to that of battery LTO-al with the exception of the fact that the acidification step is eliminated. In FIG. 1, this battery is referenced LTO-3 and its grammage, of 16 mg/cm², is substantially identical to that of battery LTO-a1. Battery LTO-3 is tested with an identical protocol to that described in the foregoing. The electrochemical tests give lower specific capacity results than those of the lithium batteries LTO-o1 and LTO-o1.

### Compression and Winding Tests

A series of electrodes having a grammage of 16 mg/cm² are also obtained from a layer of aqueous ink with a thickness of 300 μm.

A series of compression tests are performed on the electrodes obtained by aqueous route referenced LTO-a2, LTO-a3 and LTO-a4, each having a grammage of 16 mg/cm².

Another series of compression tests were performed, for comparative purposes, on the electrodes obtained by organic route referenced LTO-o2, LTO-o3 and LTO-o4, fabricated under similar conditions to electrodes LTO-a2, LTO-a3 and LTO-a4 with the exception of the fact that the demineralised water is replaced by an organic solvent, NMP, and that the binder is PVDF.

The compression time for each tested electrode is 10 seconds after drying.

As represented in FIG. 2, for the same pressure, lower porosities are obtained for the series of electrodes LTO-a2, LTO-a3 and LTO-a4 as compared with electrodes LTO-o2, LTO-o3 and LTO-o4. The initial structuration of the electrode formulated by aqueous route therefore enables a dense electrode to be obtained under a lower pressure than for an electrode formulated by organic route.

A series of winding tests were performed on electrodes referenced LTO-a, formulated by aqueous route according to the fabrication method of the invention, and comparatively on electrodes referenced LTO-o formulated by organic route. The tested electrodes have a grammage of 16 mg·cm⁻² and are densified at a porosity of 30%, 35% or 38% by modulating the calandering step in order to evaluate their respective flexibility.

This test consists in defining the minimum diameter of the mandrel, noted Dₘ, able to be used to wind an electrode without causing damage to said electrode.

The results are set out in the following table:

| | Porosity = 38% | | Porosity = 35% | | Porosity = 30% | |
|---|---|---|---|---|---|---|
| | LTO-a | LTO-o | LTO-a | LTO-o | LTO-a | LTO-o |
| Dₘ | 2 mm | 12 mm | 2 mm | 12 mm | 2 mm | 12 mm |

The results show a greater flexibility for electrodes LTO-a as compared with electrodes LTO-o whatever the porosity of the electrode, enabling more energetically dense coils to be produced.

The aqueous ink according to the invention is remarkable in particular in that it contains a non-toxic and economic aqueous solvent. Furthermore, the aqueous ink according to the invention is non-corrosive for the current collector, in particular for metallic current collectors containing aluminium or made from aluminium.

The electrodes obtained by the fabrication method according to the invention present an excellent strength and a good electric conduction. The solid layer of the electrode thus adheres perfectly to the current collector ensuring continuity of the electric conduction between said layer and the current collector. Furthermore, the aqueous ink according to the invention enables a dense electrode to be obtained without requiring calandering under high pressure and having equivalent electrochemical performances to those of electrodes obtained by organic route.

Furthermore, the electrodes obtained by means of the method according to the invention present a sufficient flexibility necessary for certain applications.

These electrodes with a grammage of more than 10 mg·cm⁻² can in particular be used for winding of cylindrical elements.

1-14. (canceled)

15. A method for fabricating an electrode comprising coating of an aqueous ink over the whole or part of a current collector followed by drying of said ink, wherein the aqueous ink is produced by acidification of an aqueous dispersion comprising an electrochemically active material having a titanium and lithium oxide base until a pH value comprised between 9.0±0.1 and 10.0±0.1 is obtained.

16. The method according to claim 15, wherein the value of the pH of the aqueous ink is equal to 10±0.1.

17. The method according to claim 15, wherein the electrochemically active material having a titanium and lithium oxide base is chosen from Li₄Ti₅O₁₂, Li₍₄₋ₓ₎MₓTi₅O₁₂ and Li₄Ti_{(5-y)}N_{y}O₁₂, where x and y are respectively comprised between 0 and 0.2 and M and N are respectively chemical elements chosen from Na, K, Mg, Nb, Al, Ni, Co, Zr, Cr, Mn, Fe, Cu, Zn, Si and Mo.

18. The method according to claim 17, wherein the electrochemically active material having a titanium and lithium oxide base is Li₄Ti₅O₁₂.

19. The method according to claim 15, wherein the aqueous dispersion comprises the electrochemically active material, at least one electron conductor, at least one binder and water, said binder being at least partially soluble in water.

20. The method according to claim 15, wherein the acidification step is performed by addition under stirring of an acid aqueous solution in the aqueous dispersion.

21. The method according to claim 15, said method comprising a step of adjusting the viscosity of the aqueous ink before coating of the latter on the current collector.

22. The method according to claim 15, wherein the current collector is aluminium-base.

23. An aqueous ink for an electrode comprising an electrochemically active material having a titanium and lithium oxide base, wherein the pH of said ink is comprised between 9.0±0,1 and 10.0±0.1.

24. The aqueous ink according to claim 23, wherein the pH is equal to 10±0.1.

25. The aqueous ink according to claim 23, wherein the electrochemically active material having a titanium and lithium oxide base is chosen from Li₄Ti₅O₁₂, Li₍₄₋ₓ₎MₓTi₅O₁₂ and Li₄Ti_{(5-y)N}_{y}O₁₂, where x and y are respectively comprised between 0 and 0.2 and M and N are respectively chemical elements chosen from Na, K, Mg, Nb, Al, Ni, Co, Zr, Cr, Mn, Fe, Cu, Zn, Si and Mo.

26. The aqueous ink according to claim 25, wherein the electrochemically active material having a titanium and lithium oxide base is Li₄Ti₅O₁₂.

27. The aqueous ink according to claim 23, said aqueous ink comprising the electrochemically active material, at least one electron conductor, at least one binder and water, the binder being at least partially soluble in water.

28. A lithium-ion battery comprising at least one electrode comprising an aqueous ink according to claim 23.
